(19) United States
(12) Patent Application Publication
(10) Pub. No.: US 2013/0044173 A1
(43) Pub. Date: Feb. 21, 2013

(54) MULTI-FUNCTION PRINTER

(71) Applicant: Shi-Ze Liu, New Taipei City (TW)

(72) Inventor: Shi-Ze Liu, New Taipei City (TW)

(73) Assignees: KINPO ELECTRONICS, INC., New Taipei City (TW); Cal-Comp Electronics & Communications Company Limited, New Taipei City (TW)

(21) Appl. No.: 13/267,894

(22) Filed: Oct. 7, 2011

(30) Foreign Application Priority Data
Aug. 18, 2011 (TW) 100129589

(51) Int. Cl. B41J 29/13

(52) U.S. Cl. 347/108

(57) ABSTRACT

A multi-function printer including a body, a door, a carriage, and a pushing lever is provided. The door assembled to the body being opened or closed relative to the body. The carriage and the pushing lever are movably disposed in the body, wherein the pushing lever moves between a first and a second positions relative to the body. The pushing lever located at the first position has an end on a moving path of the carriage, and the door is on a moving path of the other end of the pushing lever. When the carriage moves to a pushing segment, the carriage drives the pushing lever to move from the first position to the second position, such that the pushing lever pushes open the door relative to the body.

### CROSS-REFERENCE TO RELATED APPLICATION

This application claims the priority benefit of Taiwan application serial no. 100129589, filed on Aug. 18, 2011. The entirety of the above-mentioned patent application is hereby incorporated by reference herein and made a part of this specification.

### BACKGROUND OF THE INVENTION

1. Field of the Invention

The invention relates to a multi-function printer, and more particularly to a multi-function printer having a door opening structure.

2. Description of Related Art

As the information society arrives, office automatic equipment such as scanners, photocopiers, or printers are disposed in offices, and users may perform secretarial processing operations using these office equipment. It should be noted that when the above plurality of office automatic equipment is simultaneously disposed in the office, a lot of space is consumed. As a result, a multi-function printer (MFP) integrated with functions such as copying, printing, and scanning is developed to resolve the above problem.

Furthermore, information is gradually entering a cloud computing stage, improving the processing speed and convenience when using information. Cloud computing uses the high computing and large storage capacity of a server group through the internet. This way, cloud computing replaces the original software installed on personal computers, or replaces the action of saving information on a personal hard disk. Instead, multiple actions are performed through the internet, and information is stored on the internet, a large virtual space. In other words, users can use cloud computing to perform MPF operations without the restrictions of time and location.

### SUMMARY OF THE INVENTION

The invention provides a multi-function printer with an automatic door opening structure.

An embodiment of the invention provides a multi-function printer including a body, a door, a carriage and a pushing lever. The door is assembled to the body and is capable of being opened or closed. The carriage and the pushing lever are movably disposed in the body respectively. The pushing lever moves between a first position and a second position relative to the body. An end of the pushing lever located at the first position is located on a moving path of the carriage. And the door is located on a moving path of the other end of the pushing lever, so that when the carriage is located at a pushing segment of the moving path of the carriage, the carriage drives the pushing lever to move from the first position to the second position, and the pushing lever pushes the door to be opened relative to the body.

According to an embodiment of the present invention, a moving direction of the carriage is perpendicular to a moving direction of the pushing lever.

According to an embodiment of the present invention, the moving path of the carriage further comprises a printing segment. The pushing segment is located beside the printing segment and not overlapped with the printing segment.

According to an embodiment of the present invention, the carriage has at least one ink cartridge. An end of the pushing lever located at the first position is located on a moving path of the ink cartridge.

According to an embodiment of the present invention, a distance exists between the pushing lever located at the second position and the moving path of the carriage.

According to an embodiment of the present invention, the body has a sliding slot, and the pushing lever comprises a main body, a first pushing portion and a second pushing portion. The main body is disposed in the sliding slot and capable of moving between the first position and the second position. The first pushing portion is located at an end of the main body and faces the moving path of the carriage. The second pushing portion is located at the other end of the main body and faces the door.

According to an embodiment of the present invention, a profile of the first pushing portion is a curved surface or an inclined surface.

According to an embodiment of the present invention, the pushing lever further comprises a flexible arm disposed on the main body and located between the first pushing portion and the second pushing portion.

According to an embodiment of the present invention, a deformation direction of the flexible arm is perpendicular to a moving direction of the main body.

According to an embodiment of the present invention, the flexible arm has a protrusion. And the body has a first recess and a second recess which are located on the sliding slot. Both the first recess and the second recess are located on a moving path of the protrusion. When the protrusion is located at the first recess the pushing lever is located at the first position. When the protrusion is located at the second recess the pushing lever is located at the second position.

According to an embodiment of the present invention, the first recess has an orienting surface and a guiding surface which are connected to each other, and the second recess has an orienting surface and a guiding surface which are connected to each other. And the guiding surface has a surface profile inclined to the orienting surface.

In light of the above, in the embodiment of the present invention, through the pushing lever disposed between the carriage and the door, the pushing lever can be driven to push the door to be opened when the carriage of the multi-printer moves to the pushing segment. In such way, the user does not need to manually control the multi-function printer, but uses the moving mode of the original carriage of the moving mechanism to ensure the actuating of the door. And this allows the multi-function printer to satisfy the functional requirements of cloud equipment.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 and FIG. 2 are schematic views respectively illustrating a multi-function printer in different conditions according to an embodiment of the invention.

FIG. 3 is a partial side view of the multi-function printer of FIG. 1.

FIG. 4 is a partial top view of the multi-function printer of FIG. 1.

FIG. 5 is a partial side view of the multi-function printer of FIG. 3 in another condition.

FIG. 6 is a partial top view of the multi-function printer of FIG. 4 in another condition.

FIG. 7 and FIG. 8 respectively illustrate schematic views of the pushing levers of the multi-function printer in FIG. 4 and FIG. 6 located in different locations.

FIG. 9 is a partial enlarged view illustrating the sliding slot of FIG. 8.

FIG. 10 is a schematic partial side view of a multi-function printer according to another embodiment of the present invention.

FIG. 11 is a schematic view of the pushing lever and the supporting element of the multi-function printer of FIG. 10.

FIG. 12 is a schematic bottom view of the pushing lever and the supporting element of the multi-function printer of FIG. 10.

### DESCRIPTION OF EMBODIMENTS

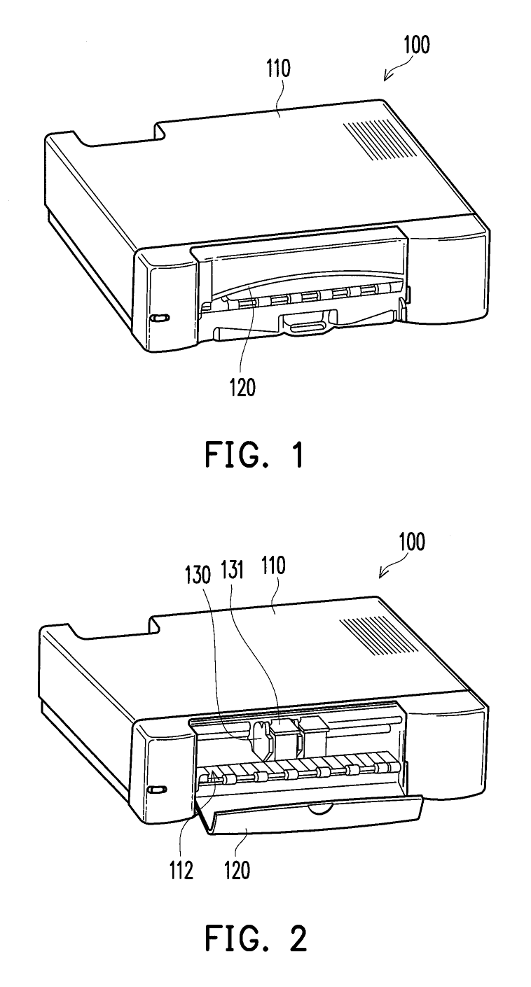

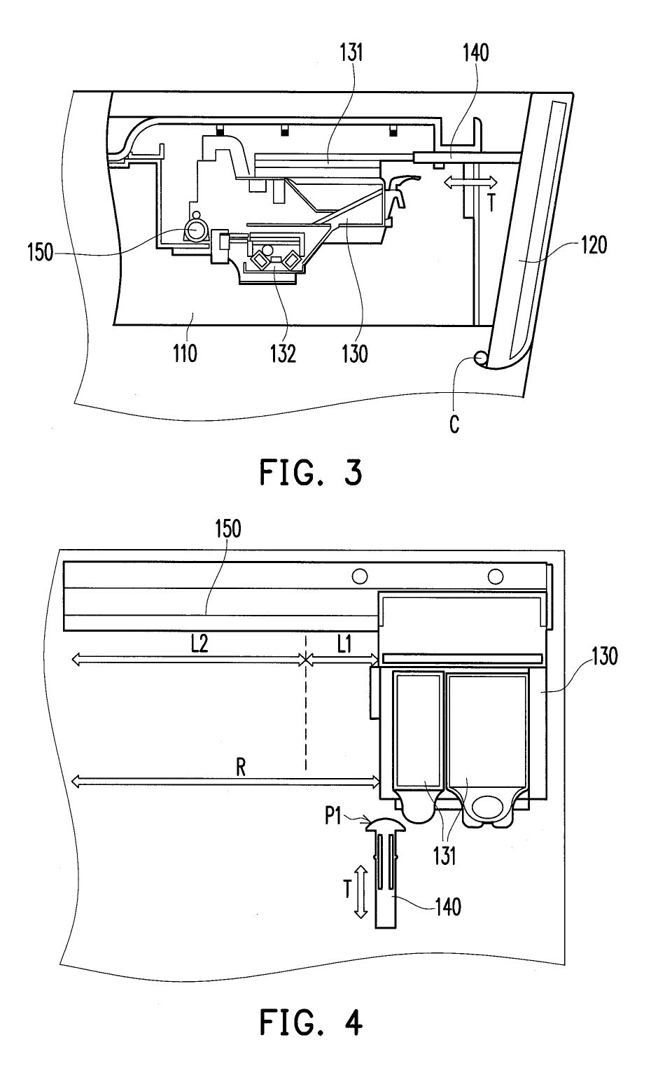

FIG. 1 and FIG. 2 are schematic views respectively illustrating a multi-function printer in different conditions according to an embodiment of the invention. FIG. 3 is a partial side view of the multi-function printer of FIG. 1. FIG. 4 is a partial top view of the multi-function printer of FIG. 1. Referring to FIG. 1 to FIG. 4, in the embodiment, the multi-function printer 100 includes a body 110, a door 120, a carriage 130 and a pushing lever 140. The body 110 has a paper outlet 112. The door 120 is pivoted to the body 110, and suitable for rotating along a shaft C relative to the body 110 to open or enclose the paper outlet 112. Herein the printed or scanned paper (not shown) is passed through the paper outlet 112 from the body 110 and transmitted out from the multi-function printer 100, in the condition that the door 120 is opened relative to the body 110 (as shown in FIG. 2).

The carriage 130 is disposed within the body 110, has an ink cartridge 131 and an inkjet printhead 132 and connected to a transmitting mechanism 150. The carriage 130 is driven by the transmitting mechanism 150 and moves back and forth along a moving path R. Thus, the inkjet printhead 132 disposed upon the carriage 130 can be indirectly driven by the transmitting mechanism 150 to move and execute the inkjet printing operations. And the disposing of the pushing lever 140 of the embodiment can be on the moving path of the ink cartridge 131 so as to push the door 120 through the driving of the ink cartridge 131. However, the form of the carriage 130 is not limited thereby, and in another embodiment not shown in the figures, an image extracting module can also be disposed on the carriage so that the carriage can similarly move and execute the image scanning operations by using the transmitting mechanism 150.

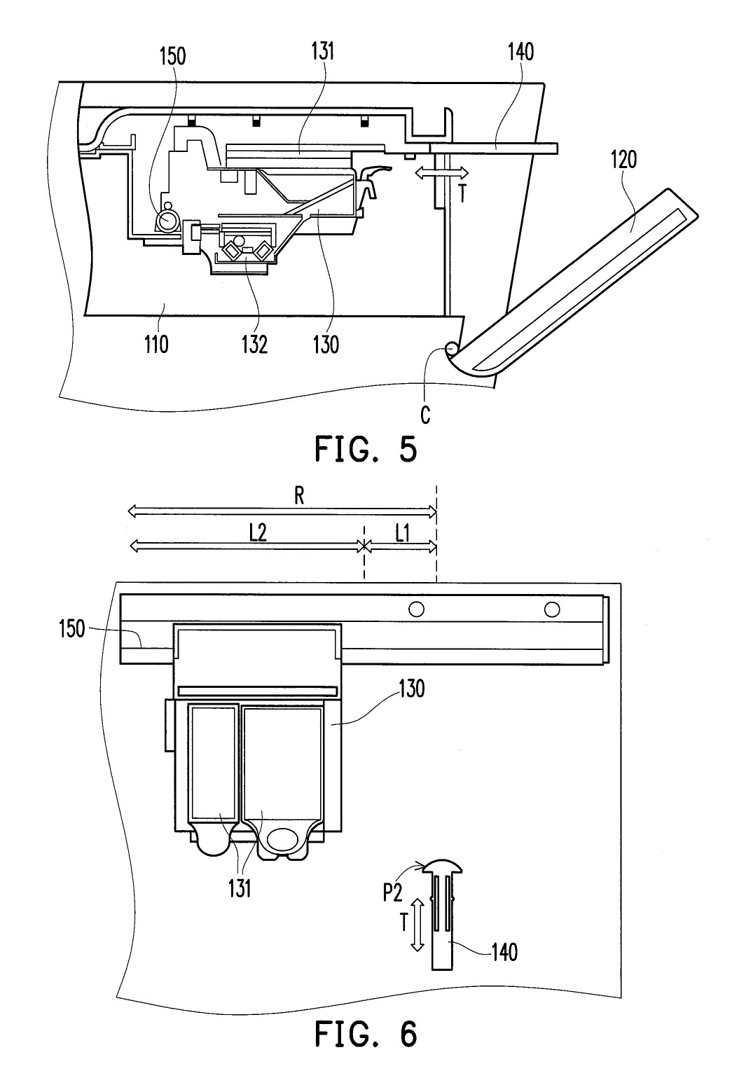

FIG. 5 is a partial side view of the multi-function printer of FIG. 3 in another condition. FIG. 6 is a partial top view of the multi-function printer of FIG. 4 in another condition. Referring FIG. 3 to FIG. 6, it has to be noted that the pushing lever 140 is slidably disposed to the body 110 and moves between a first position P1 and a second position P2. Herein, an end of the pushing lever 140 located at the first position P1 is located on the moving path R of the carriage 130. And the door 120 is located on a moving path T of the other end of the pushing lever 140. The moving path R of the carriage 130 is perpendicular to the moving path T of the pushing lever 140.

Accordingly, when the carriage 130 is located at a pushing segment L1 which is located on the moving path, the carriage 130 drives the pushing lever 140 to move from the first position P1 to the second position P2. And the preparation before printing (or scanning) is completed after the pushing lever 140 pushes the door 120 to be opened relative to the body 110. On the contrary, when the multi-function printer 100 is not to be used and the door 120 has to be closed, the door 120 may drive the pushing lever 140 to move from the second position P2 to the first position P1. In this way the pushing lever 140 returns to its original state and ready to repeat the movement indicated above for the next time.

More specifically, the moving path R of the carriage 130 in the present embodiment includes a printing segment L2 and the pushing segment L1 which are not overlapped to each other and already in the multi-function printer 100. That is, regardless of the carriage 130 used in the scanning function or the printing function, the moving path R can be classified into the operating area which is located at the central area and the non-operating area located at the rest of the moving path R. For example, in the present embodiment, the moving area when the carriage 130 does not operate the printing process is defined as the pushing segment L1. When the carriage 130 does not operate the printing (or scanning) process, since the carriage 130 moves to the pushing segment L1 such that the pushing lever 140 can be driven. That is to say, as for the order of positions, the pushing segment L1 is located before the printing segment L2 relative to the carriage 130, so as to ensure the door 120 open before the carriage 130 moves into the printing segment L2. In addition, since the printing segment L2 and the pushing segment L1 are not overlapped to each other, it can avoid the two operations (printing and pushing) interfering with each other. However, the ranges of the printing segment L2 and the pushing segment L1 are not limited herein the present invention. In another embodiment not shown in the figure, the pushing segment L1 can be overlapped with the printing segment L2, i.e., the sliding range (the printing segment L2) of the carriage 130 can also be taken as the pushing segment L1 which is used in actuating the door 120.

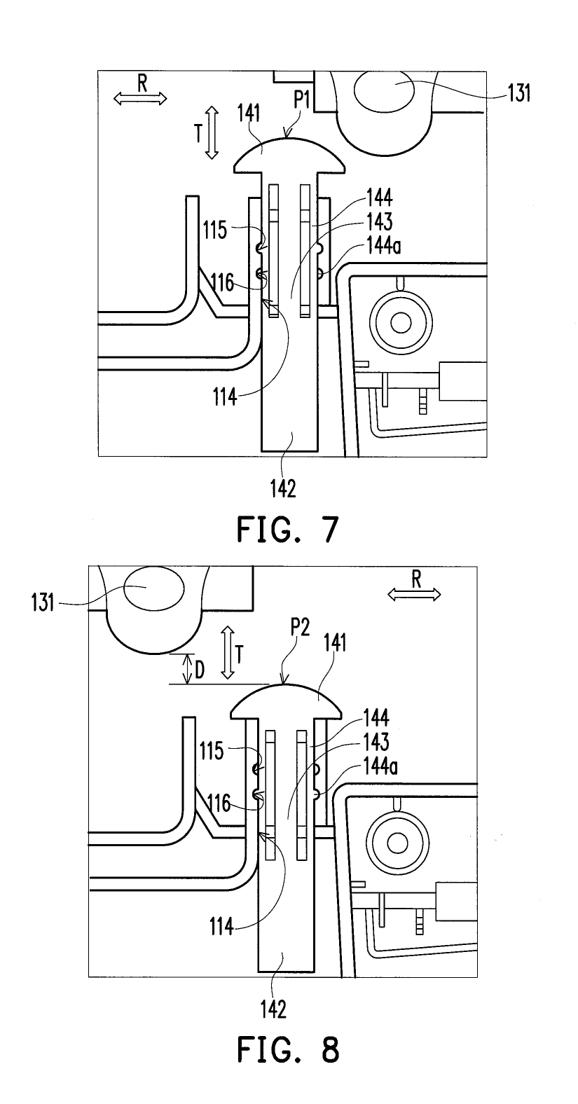

FIG. 7 and FIG. 8 respectively illustrate schematic views of the pushing levers of the multi-function printer in FIG. 4 and FIG. 6 located in different locations. Referring to FIG. 4, FIG. 6, FIG. 7 and FIG. 8, in the present embodiment, the pushing lever 140 includes a main body 143, a first pushing portion 141 and a second pushing portion 142 respectively located at two opposite ends of the main body 143. Herein the main body 143 is slidably disposed in a sliding slot 114 of the body 110. The first pushing portion 141 faces the moving path R of the carriage 130, and the second pushing portion 142 faces the door 120.

More particularly, the profile of the first pushing portion 141 is a curved surface, so that a side of the ink cartridge 131 can push the first pushing portion 141 along the curved surface to further smooth the moving process of the pushing lever 140 and the carriage 130. The profile of the first pushing portion 141 is not limited in the present invention. In another embodiment not shown in figure, the profile of the first pushing portion 141 can also be an inclined surface which is inclined along the moving path R of the carriage 130. Furthermore, in order to avoid the condition of bumping the pushing lever 140 during the movement of the carriage 130, when the pushing lever 140 is pushed by the carriage 130 and moves to the second position P2, a distance D, taken as the safety distance, exists between the location where the first pushing portion 141 is located and the moving path R of the carriage 130.

Additionally, the pushing lever 140 further includes a flexible arm 144 disposed on the main body 143 and located between the first pushing portion 141 and the second pushing portion 142. The flexible arm 144 is formed by partially hollowing out the main body 143, for example. The deformation direction of the flexible arm 144 is perpendicular to the moving direction of the main body 143. The flexible arm 144 is symmetrically disposed on two opposite sides of the main body in the embodiment, but it is not limited in the present invention. More importantly, the flexible arm 144 has a protrusion 144a. And the body 110 has a first recess 115 and a second recess 116 which are located on the sliding slot 114. And both the first recess 115 and the second recess 116 are located on a moving path of the protrusion 144a. In this way, when the protrusion 144a is located at the first recess 115, then the pushing lever 140 is located at the first position P1. And when the protrusion 144a is located at the second recess 116, then the pushing lever 140 is located at the second position P2. In other words, the pushing lever 140 can be stopped at the first position P1 or the second position P2 to reach the purpose of positioning the pushing lever 140 due to the collocation of the protrusion 144a and the recesses 115, 116.

In light of the above, when the multi-function printer 100 is in the state of FIG. 3 and FIG. 4, the carriage 130 is located at the pushing segment L1 and does not move, i.e., the multi-function printer 100 is in a non-operating state (off-state or sleep mode). After that, when the multi-function printer 100 is remotely initiated and before the user transmits data to be printed, the carriage 130 moves from the pushing segment L1 to the printing segment L2. During the moving process, the carriage 130 pushes the pushing lever 140 to move toward the door 120 within the sliding slot 114, and then the pushing lever 140 pushes the door 120 out of the closed-position (as shown in FIG. 3) so that the door 120 rotates to the opened-position (as shown in FIG. 5) due to its own weight. In this way, before the carriage 130 of the multi-function printer 100 moves into the printing segment L2, the actuating of the door 120 is ensured and the printing paper being obstructed by the door 120 during printing process can be avoided.

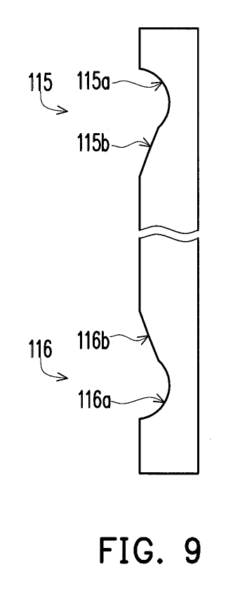

In addition, FIG. 9 is a partial enlarged view illustrating the sliding slot of FIG. 8. In the embodiment, in order to ensure the movement of the pushing lever 140 when it moves, thus the first recess 115 has an orienting surface 115a, and a guiding surface 115b, the second recess 116 has an orienting surface 116a and a guiding surface 116b. Herein the guiding surfaces 115b, 116b respectively have a surface profile inclined to the orienting surfaces 115a, 116a, i.e., the guiding surface 115b of the first recess 115 inclines to the orienting surface 115a, and the guiding surface 116b of the second recess 116 inclines to the orienting surface 116a.

Accordingly, the guiding surfaces 115b, 116b are located between the orienting surfaces 115a, 116a and back to back with each other, as shown in FIG. 9. For example, when the pushing lever 140 moves from the first position P1 to the second position P2, when the protrusion 144a disposed on the flexible arm 144 reaches to the guiding surface 116b of the second recess 116, the protrusion 144a can automatically move to the orienting surface 116a along the guiding surface 116b due to the effect of the surface profile. On the contrary, when the pushing lever 140 moves from the second position P2 to the first position P1, the guiding surface 115b of the first recess 115 also can automatically drive the protrusion 144a to move to the orienting surface 115a when the protrusion 114a arrives.

In other words, regardless of the carriage 130 driving the pushing lever 140 or closing the door 120 to driving the pushing lever 140, it is unnecessary to completely run the whole path between the first recess 115 and the second recess 116, instead the existing of the guiding surfaces 115b, 116b ensures the movement of the pushing lever 140 moving within the sliding slot 114. In addition, the guiding surface 116b of the second recess 116 can consequently increase the moving distance of the main body 143 moving toward the second position P2, so as to ensure the first pushing portion 141 of the pushing lever 140 to keep the safety distance with the moving path R of the carriage 130.

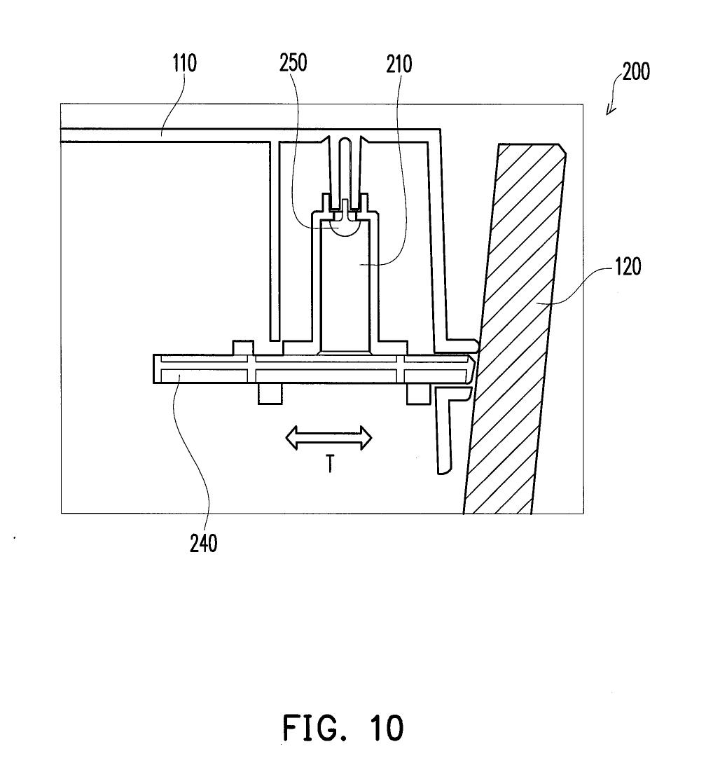

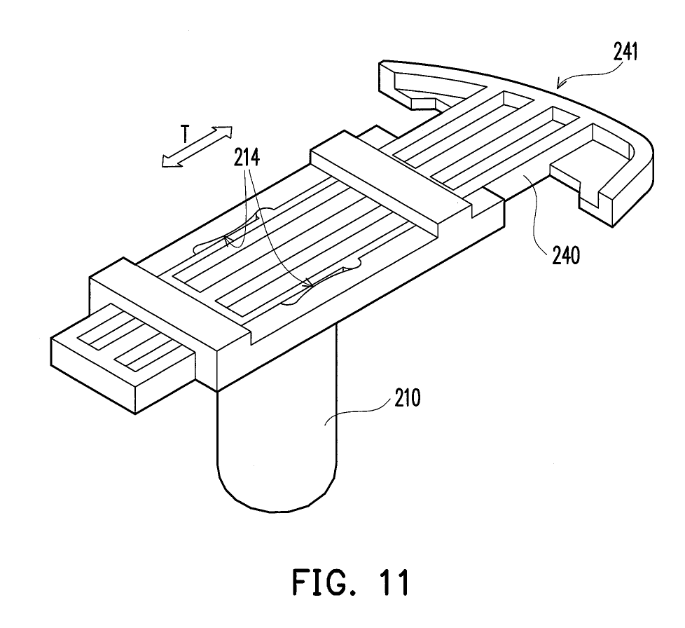

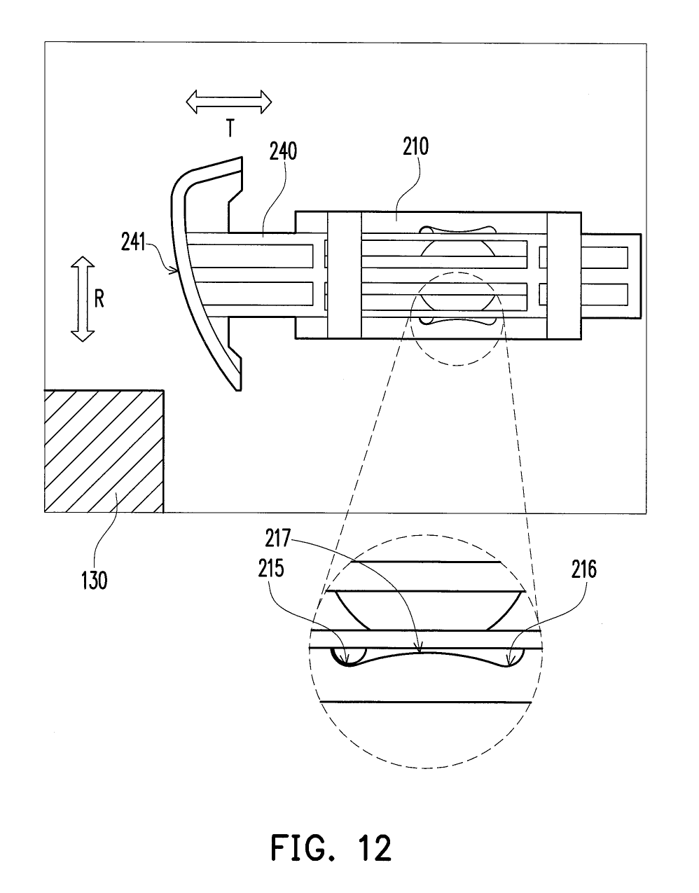

FIG. 10 is a schematic partial side view of a multi-function printer according to another embodiment of the present invention. FIG. 11 is a schematic view of the pushing lever and the supporting element of the multi-function printer of FIG. 10. FIG. 12 is a schematic bottom view of the pushing lever and the supporting element of the multi-function printer of FIG. 10. Referring to FIG. 10 to FIG. 12, the difference between the present embodiment and the above mentioned embodiment is that, the multi-function printer 200 further includes a supporting element 210 disposed on the body 110 and has a sliding slot 214 so that the pushing lever 240 can be slidably disposed on the supporting element 210 to complete the actuating of the door 120. In such way, it is unnecessary to redesign and modify the multi-function printer 200, the pushing lever 240 can be adaptable to the existing body 110 by just disposing the supporting element 210 so as to reduce the additional manufacturing cost due to the redesign and modification of the body 110. In the embodiment, the supporting element 210 can be screwed to the body 110 through a screw 250, but it is not limited by the present invention. Any other suitable related mechanisms and methods capable to assemble the supporting element 210 to the body can be used in the present invention.

Furthermore, referring to FIG. 12, in the embodiment, the first pushing portion 241 of the pushing lever 240 is in an asymmetric curved surface profile facing the carriage 130, so as to facilitate the carriage 130 to push the pushing lever 240 along the smoother curved surface.

In addition it should be noted that, the guiding surface 217 disposed on the sliding slot 214 and located between the first recess 215 and the second recess 216 is also a curved profile smoothly heading toward the two recesses 215, 216. Thus, the step height distance between the guiding surface 217 and the recesses 215, 216 can be reduced so as to provide a smoother sliding path for the pushing lever 240.

In light of the above, in the embodiment of the present invention, through the pushing lever disposed between the carriage and the door, when the carriage of the multi-function printer moves to the pushing segment, the pushing lever can be driven to push the door to be opened. In such way, the user does not need to manually control the multi-function printer, but uses the moving mode of the original carriage of the moving mechanism to ensure the actuating of the door. And this allows the multi-function printer to satisfy the functional requirements of cloud equipment.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A multi-function printer, comprising:
a body;
a door assembled to the body and capable of being opened or closed;
a carriage movably disposed in the body; and
a pushing lever disposed in the body and capable of moving between a first position and a second position relative to the body, wherein an end of the pushing lever located at the first position is located on a moving path of the carriage, and the door is located on a moving path of the other end of the pushing lever, so that when the carriage is located at a pushing segment of the moving path of the carriage, the carriage drives the pushing lever to move from the first position to the second position, and the pushing lever pushes the door to be opened relative to the body.

2. The multi-function printer as claimed in claim 1, wherein a moving direction of the carriage is perpendicular to a moving direction of the pushing lever.

3. The multi-function printer as claimed in claim 1, wherein the moving path of the carriage further comprises a printing segment, the pushing segment is located beside the printing segment and not overlapped with the printing segment.

4. The multi-function printer as claimed in claim 1, wherein the carriage has at least an ink cartridge, and an end of the pushing lever located at the first position is located on a moving path of the ink cartridge.

5. The multi-function printer as claimed in claim 1, wherein a distance exists between the pushing lever located at the second position and the moving path of the carriage.

6. The multi-function printer as claimed in claim 1, wherein the body has a sliding slot, and the pushing lever comprises:
a main body disposed in the sliding slot and capable of moving between the first position and the second position;
a first pushing portion located at an end of the main body, and facing the moving path of the carriage; and
a second pushing portion located at the other end of the main body, and facing the door.

7. The multi-function printer as claimed in claim 6, wherein a profile of the first pushing portion is a curved surface or an inclined surface.

8. The multi-function printer as claimed in claim 6, wherein the pushing lever further comprises:
a flexible arm disposed on the main body and located between the first pushing portion and the second pushing portion.

9. The multi-function printer as claimed in claim 8, wherein a deformation direction of the flexible arm is perpendicular to a moving direction of the main body.

10. The multi-function printer as claimed in claim 8, wherein the flexible arm has a protrusion, and the body has a first recess and a second recess which are located on the sliding slot, and both the first recess and the second recess are located on a moving path of the protrusion, when the protrusion is located at the first recess the pushing lever is located at the first position, when the protrusion is located at the second recess the pushing lever is located at the second position.

11. The multi-function printer as claimed in claim 10, wherein the first recess has an orienting surface and a guiding surface which are connected to each other, and the second recess has an orienting surface and a guiding surface which are connected to each other, and the guiding surface has a surface profile inclined to the orienting surface.
